(19) United States
(12) Patent Application Publication
(10) Pub. No.: US 2025/0167287 A1
(43) Pub. Date: May 22, 2025

(54) LITHIUM-ION BATTERY

(71) Applicant: TOYOTA JIDOSHA KABUSHIKI KAISHA, Toyota-shi (JP)

(72) Inventor: Masaharu SENOUE, Seto-shi (JP)

(73) Assignee: TOYOTA JIDOSHA KABUSHIKI KAISHA, Toyota-shi (JP)

(21) Appl. No.: 18/895,985

(22) Filed: Sep. 25, 2024

(30) Foreign Application Priority Data
Nov. 17, 2023 (JP) 2023-195779

(51) Int. Cl. H01M 10/0525; H01M 4/02; H01M 4/36; H01M 4/38; H01M 4/58; H01M 4/583

(52) U.S. Cl. CPC H01M 10/0525; H01M 4/366; H01M 4/386; H01M 4/5825; H01M 4/583; H01M 2004/021; H01M 2004/027

(57) ABSTRACT

The lithium-ion battery includes a cathode, an anode, and an electrolytic solution. The cathode includes a cathode active material layer. The cathode includes a flat portion and a groove portion. A thickness of the cathode active material layer in the groove portion is smaller than a thickness of the cathode active material layer in the flat portion. The anode includes an anode active material layer. The anode active material layer includes a first portion and a second portion. The first portion faces the flat portion. The second portion faces the groove portion. The anode active material layer includes an anode active material. In the first portion, the anode active material contains silicon. In the second portion, the anode active material is at least one type selected from a group consisting of graphite and lithium titanate.

### CROSS-REFERENCE TO RELATED APPLICATION

This application claims priority to Japanese Patent Application No. 2023-195779 filed on Nov. 17, 2023, incorporated herein by reference in its entirety.

### BACKGROUND

### 1. Technical Field

The present disclosure relates to a lithium-ion battery.

### 2. Description of Related Art

Japanese Unexamined Patent Application Publication No. 2023-101952 (JP 2023-101952 A) discloses a cathode active material layer having a groove portion.

### SUMMARY

Providing a groove portion in a cathode active material layer in a lithium-ion battery (hereinafter may be abbreviated to “battery”) has been studied. The groove portion can form a flow path for an electrolytic solution. Reduction in the amount of time required for impregnation by the electrolytic solution (hereinafter also referred to as “impregnation time”) at the time of manufacturing the battery is expected from this groove portion. Now, a silicon (Si)-based anode active material has been studied for the purpose of increasing energy density of batteries. According to newly-acquired knowledge, there is a possibility that combining the cathode active material layer having the groove portion with an anode active material layer including the Si-based anode active material will cause deterioration of cycle characteristics. Also, increasing the energy density of batteries requires design with a high basis weight, and accordingly there has been room for improvement when manufacturing such an electrode in particular.

An object of the present disclosure is to improve cycle characteristics.
1. A lithium-ion battery includes a cathode, an anode, and an electrolytic solution.

The cathode includes a cathode active material layer.

The cathode includes a flat portion and a groove portion.

A thickness of the cathode active material layer in the groove portion is smaller than a thickness of the cathode active material layer in the flat portion.

The anode includes an anode active material layer.

The anode active material layer includes a first portion and a second portion.

The first portion faces the flat portion.

The second portion faces the groove portion.

The anode active material layer includes an anode active material.

In the first portion, the anode active material contains silicon.

In the second portion, the anode active material is at least one type selected from a group consisting of graphite and lithium titanate.

Hereinafter, the term “anode capacity per unit area” may be abbreviated to “anode capacity”. The same applies to “cathode capacity per unit area”. In the cathode active material layer, the cathode capacity of the groove portion is lower than the cathode capacity of the flat portion (non-groove portion). Accordingly, in the anode active material layer, a portion (second portion) facing the groove portion of the cathode active material layer has a lower charge state in comparison with a portion (first portion) facing the flat portion of the cathode active material layer. A discharge curve of Si-based anode active material tends to have a sloped form. That is to say, potential gradually increases in accordance with discharge. Thus, potential difference between the first portion and the second portion tends to readily increase. Increase in the potential difference can promote diffusion of lithium (Li) ions from the first portion to the second portion. It is thought that the greatness of the amount of Li ions diffused from the first portion to the second portion is what contributes to deterioration in cycle characteristics.

In the battery described in “1” above, the anode active material is different between the first portion and the second portion. The first portion includes an Si-based anode active material. The second portion includes at least one selected from the group consisting of graphite and lithium titanate (Li₄Ti₅O₁₂, LTO). The discharging curves of graphite and LTO include a plateau. That is to say, the discharge curve includes a flat portion. Accordingly, even when Li ions are diffused from the first portion to the second portion, a rate of diffusion of the Li ions in the second portion is expected to be significantly reduced. As a consequence, the rate of diffusion of Li ions from the first portion to the second portion can become slower. Thus, an improvement in cycle characteristics is expected.
2. The lithium-ion battery described in “1” above may include, for example, the following configuration.

The thickness of the cathode active material layer in the groove portion is zero.

The groove portion may be blank. That is to say, the cathode active material layer may not be present in the groove portion. The impregnation time is expected to be shortened due to the groove portion being blank.
3. The lithium-ion battery described in the above “1” or “2” may include, for example, the following configuration.

The relation in Expression (1) below is satisfied.

$$0.05 \leq C 2 / C 1 \qquad ( 1 )$$

where, in Expression (1),
C1 represents an anode capacitance per unit area in the first portion, and
C2 represents an anode capacitance per unit area in the second portion.

Satisfying the relation of Expression (1) above is expected to reduce short-circuit failures.
4. The lithium-ion battery according to any one of the above “1” to “3” may include, for example, the following configuration.

At least one of relations of Expressions (2) and (3) below is satisfied.

$$30 mg / {cm}^{2} \leq Ma \qquad ( 2 )$$

$$100 μm \leq Ta \qquad ( 3 )$$

where, in Expression (2), Ma represents a basis weight of the cathode active material layer in the flat portion.

In Expression (3), Ta represents the thickness of the cathode active material layer in the flat portion.

When at least one of the relations of the above Expressions (2) and (3) is satisfied, the impregnation time of the electrolytic solution tends to be particularly long. In other words, when at least one of the relations of the above Expressions (2) and (3) is satisfied, it is conceivable that the necessity of the groove portion is particularly high.
5. The lithium-ion battery according to any one of the above “1” to “4” may include, for example, the following configuration.

The anode active material layer includes a first layer and a second layer.

The first portion includes the first layer and the second layer.

In the first portion, the second layer is laminated on the first layer.

The second portion is made up of the first layer or the second layer.

The second layer is of a different composition from the first layer.

The anode active material layer may have a multilayer structure. For example, the first portion and the second portion part may be formed by two layers having different compositions from each other. For example, the first portion and the second portion may be formed by coating one of the first layer and the second layer in a striped form and coating the other in a planar form.

Hereinafter, an embodiment of the present disclosure (which may hereinafter be abbreviated to “present embodiment”) and an example of the present disclosure (which may hereinafter be abbreviated to “present example”) will be described. However, the present embodiment and the present example do not limit the technical scope of the present disclosure. The present embodiment and the present example are exemplary in all respects. The present embodiment and the present example are not restrictive. The technical scope of the present disclosure includes all modifications that fall within the meaning and scope equivalent to the claims. For example, it is originally planned to optionally extract appropriate configurations from the present embodiment and optionally combine such configurations.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view showing an example of a lithium-ion battery according to the present embodiment;

FIG. 2 is a schematic plan view illustrating an example of a cathode;

FIG. 3 is a schematic cross-sectional view showing a second example of the anode active material layer;

FIG. 4 is a schematic cross-sectional view showing a third example of the anode active material layer;

FIG. 5 is a schematic cross-sectional view showing a fourth example of the anode active material layer;

FIG. 6 is a table showing experimental conditions; and

FIG. 7 is a table showing experimental results.

### DETAILED DESCRIPTION OF EMBODIMENTS

### Main Terms

The “anode capacity per unit area (unit: mAh/cm²)” is the product of the specific capacity of the active material (unit: mAh/g), the blending ratio (mass ratio) of the active material in the target part, and the basis weight (mg/cm²). The same applies to the cathode capacity. The specific capacity is measured by a unipolar test.

Geometric terms (e.g., parallel, vertical, orthogonal, etc.) should not be taken in a strict sense. For example, “parallel” may deviate somewhat from “parallel” in a strict sense. The geometric terms may include, for example, design, work, or manufacturing tolerances or variations. Dimensional relationships in each drawing may not match actual dimensional relationships. The dimensional relationships in each drawing may be changed to facilitate understanding of readers. For example, the length, width, and thickness may be changed. Some configurations may be omitted.

A “plan view” indicates viewing an object with a line of sight parallel to a thickness direction of the object. The shape of the object in a plan view is shown in a plan view.

Numerical ranges such as “m to n %” include upper and lower limits unless otherwise specified. “m to n %” indicates a numerical range of “m % or more and n % or less”. “m % or more and n % or less” includes “more than m % and less than n %”. The terms “greater than or equal to” and “less than or equal to” are represented by an equal sign inequality sign “≤”. The terms “greater than” and “less than” are represented by inequality signs “<” that do not include equal signs.

“D50” refers to the particle size at which the integration is 50% in the volume-based particle size distribution (integrated distribution). The particle size distribution can be measured by laser diffraction methods.

The stoichiometric composition formula represents a representative example of a compound. The compound may have a non-stoichiometric composition. For example, “Li₄Ti₅O₁₂” is not limited to compounds having a material content ratio (molar ratio) of “Li:Ti:O=4:5:12”. “Li₄Ti₅O₁₂” refers to compounds containing Li, Ti, and O in any molar ratio, unless otherwise specified. For example, the compound may be doped with a trace element. Some of the constituent elements may be substituted with another element.

### Lithium-Ion Battery

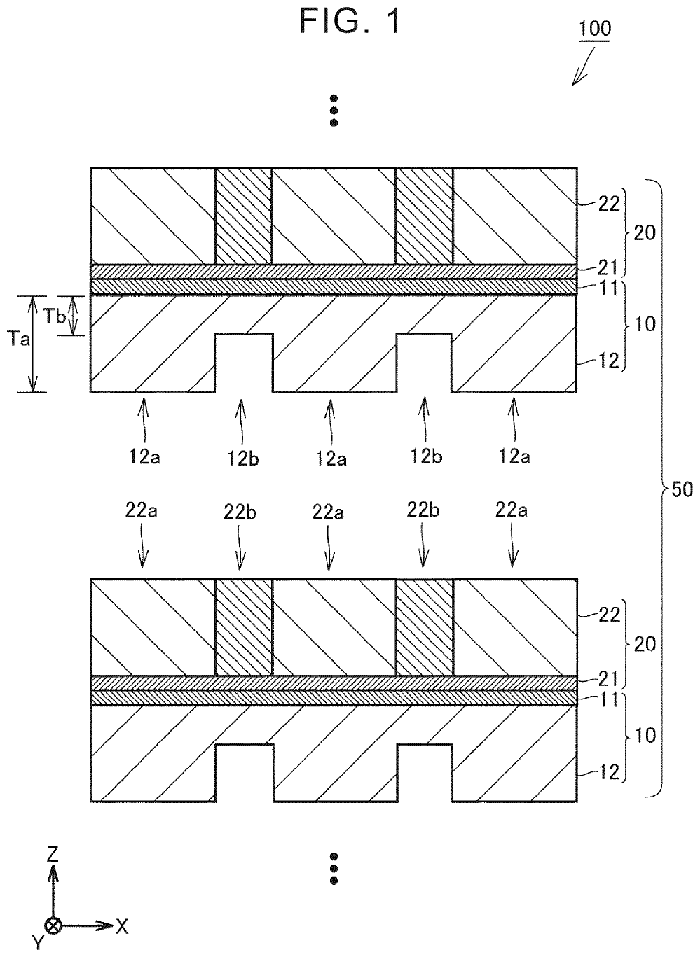

FIG. 1 is a schematic cross-sectional view illustrating an example of a lithium-ion battery according to the present embodiment. The battery 100 includes a power storage element 50 and an electrolytic solution (not shown). The battery 100 may include an exterior body (not shown). The exterior body may contain the power storage element 50 and the electrolytic solution. The sheath may have any form. The exterior body may include, for example, a metal case, a pouch made of a metal foil laminate film, and the like.

### Power Storage Element

The power storage element 50 may be referred to as, for example, an “electrode assembly”, an “electrode group”, or the like. The power storage element 50 may have, for example, a monopolar structure. The power storage element 50 may be, for example, a wound type. The power storage element 50 may have, for example, a bipolar structure. The power storage element 50 may be, for example, a stacked type.

The power storage element 50 in FIG. 1 has a bipolar structure as an example. The power storage element 50 includes, for example, a cathode 10 and an anode 20. The cathode 10 includes a cathode active material layer 12. The cathode 10 may be formed of the cathode active material layer 12. The cathode 10 may include a cathode current collector 11. The anode 20 includes an anode active material layer 22. The anode 20 may be formed of the anode active material layer 22. The anode 20 may include an anode current collector 21. For example, the cathode current collector 11 may be attached to the anode current collector 21 by a conductive adhesive (not shown). The power storage element 50 may include a plurality of cathodes 10 and a plurality of anodes 20. When the power storage element 50 has a bipolar structure, the cell voltage is adjusted according to the number of stacked cathodes 10 and anodes 20. In order to obtain a desired cell voltage (desired number of stacked layers), the basis weight and thickness of the cathode active material layer 12 tend to increase. It is considered that as at least one of the basis weight and the thickness of the cathode active material layer 12 increases, the necessity of the groove portion (the flow path of the electrolytic solution) increases.

### Cathode

The cathode active material layer 12 may be supported by the cathode current collector 11, for example. The cathode current collector 11 may include, for example, aluminum (Al), a conductive resin, or the like. The cathode current collector 11 may include, for example, an Al foil or an Al alloy foil. The thickness of the cathode current collector 11 may be, for example, 5 to 50 μm. A conductive layer may be interposed between the cathode current collector 11 and the cathode active material layer 12.

The cathode active material layers 12 include flat portions 12a and groove portions 12b. The groove portion 12b may be formed in any manner. For example, the groove portion 12b may be formed by striping. For example, the groove portion 12b may be formed by laser-processing, compression-processing, or the like on the cathode active material layers 12. The thickness (Tb) of the cathode active material layer 12 in the groove portion 12b is smaller than the thickness (Ta) of the cathode active material layer 12 in the flat portion 12a. Tb/Ta may be, for example, 0.8 or less, 0.7 or less, 0.6 or less, 0.5 or less, 0.4 or less, 0.3 or less, 0.2 or less, 0.1 or less, or zero. That is, the thickness (Tb) of the cathode active material layers 12 in the groove portions 12b may be zero. For example, the bottom surface of the groove portion 12b may be the front surface of the cathode current collector 11. In the flat portion 12a, the ratio (Ta_{min.}/Ta_{max.}) of the minimum thickness (Ta_{min.}) to the maximum thickness (Ta_{max.}) may be, for example, greater than 0.8, greater than or equal to 0.85, greater than or equal to 0.9, or greater than or equal to 0.95.

Regarding the thickness (Ta) of the cathode active material layers 12 in the flat portion 12a, for example, the relation of the following Expression (3) may be satisfied.

$$100 μm \leq Ta \qquad ( 3 )$$

The thickness (Ta) may be, for example, 10 μm or more, 50 μm or more, 100 μm or more, 150 μm or more, 200 μm or more, 300 μm or more, or 500 μm or more. The thickness (Ta) may be, for example, 1000 μm or less, 750 μm or less, 500 μm or less, 300 μm or less, or 200 μm or less.

The basis weight (Ma) of the cathode active material layers 12 in the flat portion 12a may satisfy, for example, Expression (2) below.

$$30 mg / {cm}^{2} \leq Ma \qquad ( 2 )$$

The basis weight (Ma) may be, for example, 10 mg/cm² or more, 15 mg/cm² or more, 20 mg/cm² or more, 25 mg/cm² or more, 30 mg/cm² or more, or more. The basis weight (Ma) may be, for example, equal to or greater than 35 mg/cm², equal to or greater than 40 mg/cm², equal to or greater than 45 mg/cm², or equal to or greater than 50 mg/cm². The basis weight (Ma) may be, for example, 100 mg/cm² or less, 90 mg/cm² or less, 80 mg/cm² or less, 70 mg/cm² or less, 60 mg/cm² or less, 50 mg/cm² or less, or 40 mg/cm² or less.

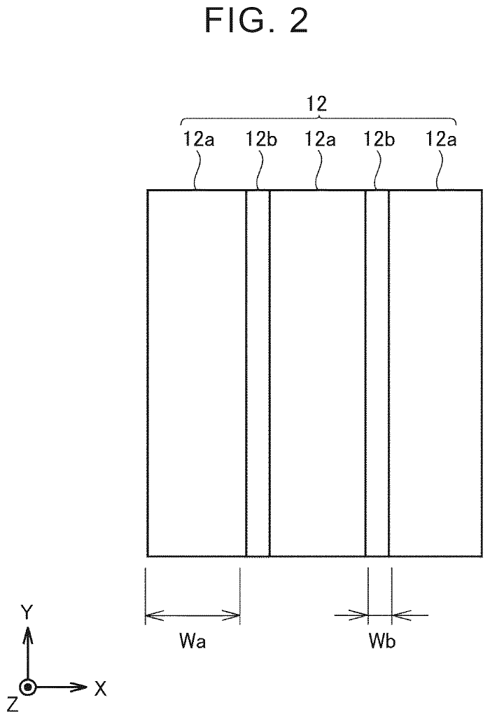

The Z direction in FIG. 1 indicates the thickness direction of the cathode active material layer 12. The X direction and the Y direction indicate a direction orthogonal to the thickness direction (an example of the in-plane direction). FIG. 2 is a schematic plan view illustrating an example of a cathode. For example, the groove portion 12b may be sandwiched between the flat portion 12a. For example, the flat portions 12a and the groove portions 12b may be alternately arranged in a direction perpendicular to the thickness direction of the cathode active material layers 12. The arrangement of the flat portions 12a and the groove portions 12b may be regular or random. The planar configuration of the groove portion 12b is optional. In a plan view, the groove portion 12b may extend linearly, for example. The groove portion 12b may extend linearly, for example. The groove portion 12b may be formed in a stripe-like shape, for example. The groove portion 12b may extend, for example, in a grid pattern. The groove portion 12b may extend across the cathode active material layers 12. The groove portion 12b may not cross the cathode active material layers 12. The groove portions 12b may be scattered in a dotted manner, for example.

In plan view, the width (Wb) of the groove portion 12b may be smaller than the width (Wa) of the flat portion 12a. Wb/Wa may be, for example, 0.90 or less, 0.80 or less, 0.70 or less, 0.60 or less, 0.50 or less, 0.40 or less, 0.30 or less, 0.20 or less, 0.10 or less, or 0.05 or less. Wb/Wa may be, for example, 0.01 or more, 0.02 or more, 0.05 or more, or 0.10 or more. Wa may be, for example, 5 to 100 mm. Wb may be, for example, 1 to 3 mm. The area (Sb) of the groove portion 12b may be smaller than the area (Sa) of the flat portion 12a. Sb/Sa may be, for example, 0.90 or less, 0.80 or less, 0.70 or less, 0.60 or less, 0.50 or less, 0.40 or less, 0.30 or less, 0.20 or less, 0.10 or less, or 0.05 or less. Sb/Sa may be, for example, 0.01 or more, 0.02 or more, 0.05 or more, or 0.10 or more.

The cathode active material layer 12 includes a cathode active material. The cathode active material may include, for example, at least one selected from the group consisting of LiCoO₂, LiNiO₂, LiMnO₂, LiMn₂O₄, Li(NiCoMn)O₂, Li(NiCoAl)O₂, and LiFePO₄. For example, “(NiCoMn)” in “Li(NiCoMn)O₂” indicates that the sum of the compositional ratios in parentheses is 1. As long as the sum is 1, the amounts of the individual components are optional. Li(NiCoMn)O₂ may include, for example, LiNi_{0.8}Co_{0.1}Mn_{0.1}O₂. D50 of the cathode active material may be, for example, 5 to 20 μm. The cathode active material layer 12 may further include a conductive material and a binder described later.

### Anode

The anode active material layer 22 may be supported by the anode current collector 21, for example. The anode current collector 21 may include, for example, copper (Cu), nickel (Ni), or a conductive resin. The anode current collector 21 may include, for example, a Cu foil or a Cu alloy foil. The thickness of the anode current collector 21 may be, for example, 5 to 50 μm. A conductive layer may be interposed between the anode current collector 21 and the anode active material layer 22.

The anode active material layers 22 include a first portion 22a and a second portion 22b. As shown in FIG. 1, the first portion 22a faces the flat portion 12a. As long as the first portion 22a faces the flat portion 12a, a part thereof may face the groove portion 12b. For example, the planar shape of the first portion 22a may correspond to the planar shape of the flat portion 12a. In plan view, the first portion 22a may be substantially similar to the flat portion 12a. The second portion 22b faces the groove portion 12b. The second portion 22b may be partially opposed to the flat portion 12a as long as it is opposed to the groove portion 12b. For example, the planar shape of the second portion 22b may correspond to the planar shape of the groove portion 12b. In plan view, the second portion 22b may be substantially similar to the groove portion 12b. The anode active material layer 22 includes an anode active material. The anode active material differs between the first portion 22a and the second portion 22b.

In the first portion 22a, the anode active material includes Si. That is, the first portion includes a Si anode active material. Si anode active material includes not only pure Si but also a compound containing Si and a material containing Si in general. Si anode active material may include, for example, at least one selected from the group consisting of Si, silicon oxide (SiO), and silicon-carbon composites (Si—C). “Si—C” refers to a complex comprising Si and C. Si—C may comprise, for example, composites. For example, Si may be supported by a carbon-based material to form a composite-particle. The carbon material may be, for example, crystalline or amorphous. The first portion may further include another anode active material as long as the first portion includes Si anode active material. The first portion may further include, for example, graphite. The graphite may be artificial graphite or natural graphite. The mixing ratio (mass ratio) of Si anode active material and the graphite may be, for example, “Si anode active material:graphite=5:95 to 95:5”, or “Si anode active material:graphite=20:80 to 80:20”. Alternatively, the mixing ratio (mass ratio) of Si anode active material and the graphite may be, for example, “Si anode active material:graphite=5:95 to 20:80”. D50 of Si anode active material may be smaller than D50 of graphite. D50 of Si active material may be, for example, 1 to 10 μm. D50 of the graphite may be, for example, 10 to 25 μm.

In the second portion 22b, the anode active material is at least one selected from the group consisting of graphite and LTO. D50 of LTO may be, for example, 10 to 25 μm.

For example, the relation of Expression (1) below may be satisfied between the anode capacity per unit area (C1) in the first portion 22a and the anode capacity per unit area (C2) in the second portion 22b.

0.05≤C2/C1 (1)

The anode capacitance ratio (C2/C1) may be, for example, 0.1 or more, 0.15 or more, 0.2 or more, 0.25 or more, 0.3 or more, 0.35 or more, 0.4 or more, 0.45 or more, 0.5 or more, 0.55 or more, or 0.6 or more. anode capacity ratio (C2/C1) may be, for example, less than 1, 0.9, 0.8, 0.7, 0.6, 0.5, 0.4, or less, or 0.3.

As shown in FIG. 1 (first embodiment of the anode active material layer 22), for example, the thickness of the first portion 22a may be equal to the thickness of the second portion 22b. In the thickness direction, the first portion 22a may not overlap with the second portion 22b.

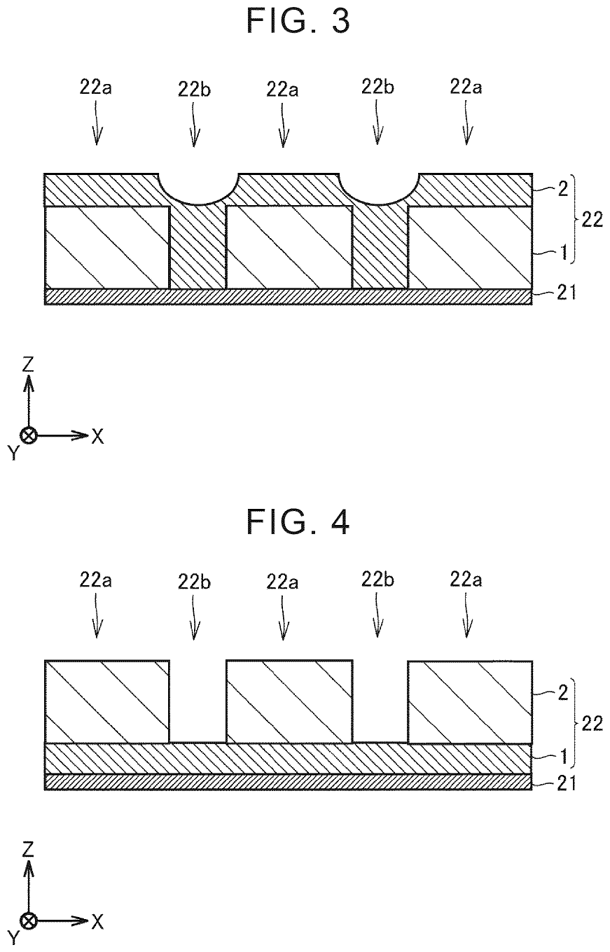

The anode active material layer 22 may have, for example, a multilayer structure. The first portion 22a and the second portion 22b may be formed by a multi-layer configuration. FIG. 3 is a schematic cross-sectional view illustrating a second example of the anode active material layer. The anode active material layer 22 may include, for example, the first layer 1 and the second layer 2. The second layer 2 has a composition different from that of the first layer 1. For example, the first layer 1 may be formed by applying the first paste in a stripe shape. The second layer 2 may be formed by applying the second paste in a planar shape from above the first layer 1. In the first portion 22a, the second layer 2 is laminated on the first layer 1. The second portion 22b comprises a second layer 2. For example, the first layer 1 may include Si. For example, the second layer 2 may include graphite. The thickness of the second portion 22b may be smaller than the thickness of the first portion 22a.

FIG. 4 is a schematic cross-sectional view illustrating a third example of the anode active material layer. For example, the first layer 1 may be formed by applying the second paste in a planar shape. The first layer 1 is flat. The second layer 2 may be formed by applying the first paste in a stripe shape from above the first layer 1. In the first portion 22a, the second layer 2 is laminated on the first layer 1. The second portion 22b comprises a first layer 1. For example, the first layer 1 may include graphite. For example, the second layer 2 may include Si. The thickness of the second portion 22b may be smaller than the thickness of the first portion 22a.

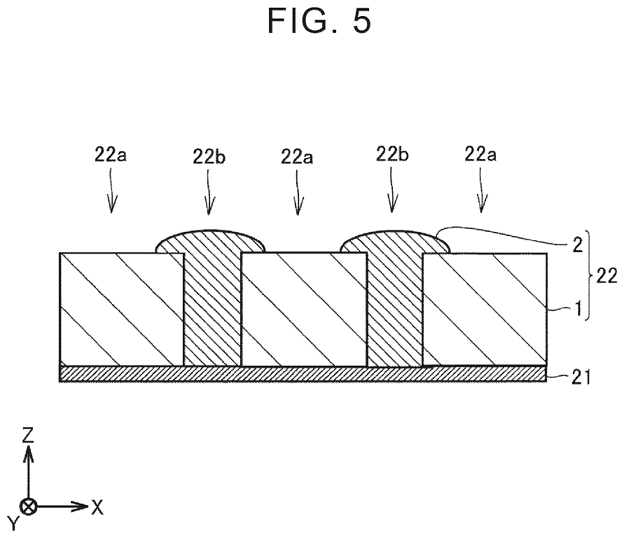

FIG. 5 is a schematic cross-sectional view showing a fourth example of the anode active material layer. The overlap of the first layer 1 and the second layer may be partial. For example, the second layer 2 may extend to cover an edge portion of the first layer 1. For example, the first layer 1 may include Si. For example, the second layer 2 may include graphite. For example, the thickness of the second portion 22b may be larger than the thickness of the first portion 22a.

The anode active material layer 22 may further include a conductive material and a binder in addition to the anode active material. The blending amount of the conductive material may be, for example, 0.1 to 10 parts by mass with respect to 100 parts by mass of the anode active material. The conductive material may include, for example, at least one selected from the group consisting of acetylene black (AB), Ketjen black (registered trademark, KB), vapor-grown carbon fiber (VGCF), carbon nanotubes (CNT), and graphene flakes (GF). The blending amount of the binder may be, for example, 0.1 to 10 parts by mass with respect to 100 parts by mass of the anode active material. The binder may include, for example, at least one selected from the group consisting of carboxymethyl cellulose (CMC), styrene-butadiene rubber (SBR), polyacrylic acid (PAA), polyimide, polytetrafluoroethylene (PTFE), and polyvinylidene fluoride (PVdF).

### Separator

The power storage element 50 may further include a separator (not shown). The separator is disposed between the cathode active material layer 12 and the anode active material layer 22. The separator is electrically insulating. The separator may include, for example, a porous film made of polyolefin. The separator may include, for example, at least one selected from the group consisting of polyethylene (PE) and polypropylene (PP). The thickness of the separator may be, for example, 5 to 50 μm, or 10 to 30 μm. The porosity of the separator may be, for example, 50 to 60%.

### Electrolytic Solution

The electrolytic solution includes Li and solvents. Li content may be, for example, from 0.5 to 2 mol/kg. Li salt may comprise at least one selected from the group consisting of LiPF₆, LiBF₄, and Li(FSO₂)₂N. The solvents may include at least one selected from the group consisting of ethylene carbonate (EC), fluoroethylene carbonate (FEC), propylene carbonate (PC), ethyl methyl carbonate (EMC), dimethyl carbonate (DMC), and diethyl carbonate (DEC). The electrolytic solution may further contain an optional additive.

### No. 1

A cathode paste was formed by mixing a cathode active material (LiNi_{0.8}Co_{0.1}Mn_{0.1}O₂, D50: 10 μm), a conductive material (AB), a binder (PVdF), and a dispersing medium (N-methyl-2-pyrrolidone, NMP). The solids formulation was “LiNi_{0.8}Co_{0.1}Mn_{0.1}O₂:AB:PVdF=93:4:3 (by weight)”. The solids concentration was 65% (mass fraction). A coating film was formed by applying a cathode paste in a stripe shape on one surface of a cathode current collector (Al foil, thickness: 30 μm) by a slit die coater. The coating width (width of the flat portion) was 10 mm. The blanking width (width of the groove portion) was 2 mm. The coating film was dried in a drying furnace to form a cathode active material layer. The drying temperature was 120° C. The drying time was 10 minutes. After being dried, the basis weight of the cathode active material layers was 35 mg/cm². The cathode active material layer was compressed by a roll press machine, whereby a cathode original fabric was produced. After compaction, the cathode active material layers had a 2.9 g/cm³. The cathode original material was cut to produce a cathode. The planar dimensions of the cathode were 24.5 cm×14.5 cm. By ultrasonic welding, a current collector tub (Al piece, width: 5 mm, thickness: 150 μm) was bonded to the back surface of the cathode current collector.

The planetary mixer mixed SiO (D50: 6 μm), graphite (spheronized natural graphite, D50: 17 μm), a conductive material (KB), a binder (PAA), and a dispersing medium (water) for 20 minutes to form a first paste. The formulation of the first paste was “SiO:graphite:KB:PAA:water=18.6:74.4:5:2:90 (by weight)”. The first paste was striped on one side of the anode current collector (Cu foil, thickness: 15 μm, width: 25 cm) by a slit die coater. The coating width (width of the first portion) was 10 mm. The blanking width (width of the second portion) was 2 mm. The first paste was dried to form a first portion. The basis weight of the first portion was 11.3 mg/cm². The first portion was compressed by a roll press machine. After compaction, the density of the first portion was 1.3 g/cm³.

The planetary mixer mixed graphite (spherical natural graphite, D50: 17 μm), a thickener (CMC), a binder (SBR), and a dispersing medium (water) for 20 minutes to form a second paste. The composition of the second paste was “graphite:CMC:SBR:dispersion medium=98:1:1:85 (by weight)”. A second paste was applied in stripes to the respective blanks (2 mm) between the first portion and the first portion by a slit die coater. A second portion (width: 2 mm) was formed by drying the second paste. The basis weight of the second portion was 6 mg/cm². As described above, the anode original material was formed. an anode was produced by cutting the anode raw material. The planar dimensions of the anode were 25 cm×15 cm. A current collector (a Ni piece, a 5 mm, and a thickness of 50 μm) was bonded to the back surface of the anode current collector by resistance-welding.

The cathode, the separator, and the anode are laminated so that the cathode active material layer and the anode active material layer face each other with the separator (PE porous film, porosity: 55%, thickness: 20 μm, plane size: 25.5 cm×15.5 cm) interposed therebetween. As a result, a power storage element was formed. The power storage element had a monopolar structure. 10 g electrolytic solution [LiPF₆ (1 mol/kg), EC:FEC:EMC:DMC=2:1:3:4 (volume ratio)], and the power storage element were housed in an outer casing (a pouch made of Al laminated film). The laminated cell of No. 1 was fabricated by vacuum-sealing the outer casing. Hereinafter, the laminated cell may be abbreviated as a “cell”.

### No. 2 to No. 17

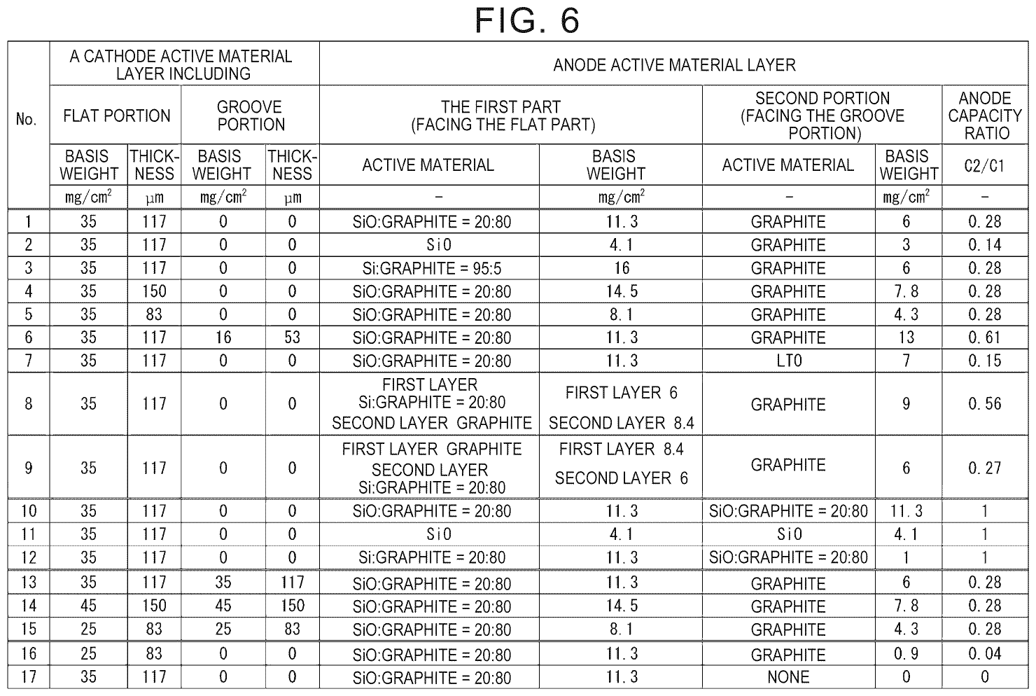

FIG. 6 is a table showing experimental conditions. The planetary mixer mixed SiO (D50: 6 μm), the polyamic acid-solution, the conductive material (KB), and the dispersing medium (NMP) for 20 minutes to form a first paste. The formulation of the first paste was “SiO:polyamic acid:KB:NMP=82:12:6:85 (by weight)”. The first paste was striped on one side of the anode current collector (Cu foil, thickness: 15 μm, width: 30 cm) by a slit die coater. The coating width (width of the first portion) was 10 mm. The blanking width (width of the second portion) was 2 mm. The first paste was dried to form a first portion. The basis weight of the first portion was 4.1 mg/cm². The first portion was compressed by a roll press machine. After compaction, the density of the first portion was 1.3 g/cm³. The polyamic acid was imidized by heat treatment at 400° C. for 30 minutes under an argon atmosphere. Further, as shown in FIG. 6, the basis weight and the like of the second portion were changed. Except for these, the cell of No. 2 was fabricated in the same way as No. 1.

The cell of No. 3 was fabricated in the same way as No. 1, except that Si (D50: 2 μm) is used instead of SiO, and as shown in FIG. 6, the basis weight of the second portion, etc. was changed.

As shown in FIG. 6, the cells of No. 4 to No. 6 were fabricated in the same way as No. 1, except that the basis weight and the like of the cathode active material layer and the anode active material layer were changed. In addition, In No. 6, the cathode active material layer was also formed in the groove portion by coating the groove portion with the cathode paste.

The planetary mixer mixed LTO (D50: 12 μm), the conductive material (KB), the binder (PVdF), and the dispersing medium (NMP) for 20 minutes to form a second paste. The formulation of the second pastes was “LTO:KB:PVdF:NMP=93:5:2:85 (by weight)”. The cell of No. 7 was made in the same way as No. 1, except that the second portion is formed by the second pasting.

The first paste was striped on one side of the anode current collector (Cu foil, thickness: 15 μm, width: 25 cm) by a slit die coater. The coating width (width of the first portion) was 10 mm. The blanking width (width of the second portion) was 2 mm. The first paste was dried to form a first layer. The basis weight of the first layer was 8.4 mg/cm². The first layer was compressed by a roll press. After compaction, the density of the first layers was 1.3 g/cm³. The second paste was applied over the first layer by a die coater to form a second layer. The target basis weight of the second layer was 6 mg/cm². However, since it was difficult to control the basis weight in the blanks, the actual basis weight in the second portion (groove-facing portion) was 9 mg/cm². Except for these, the cell of No. 8 was made in the same way as No. 1. It is considered that the anode active material layer of No. 8 has the multilayer structure of the second example (FIG. 3).

The second paste was coated on one side of the anode current collector (Cu foil, thickness: 15 μm, width: 25 cm) using a die coater. The second paste was dried to form a first layer. The basis weight of the first layer was 6 mg/cm². The first paste was applied in stripes from above the first layer by a slit die coater. The first paste was dried to form a second layer. The basis weight of the second layer was 8.4 mg/cm². The first and second layers were compressed by a roll press. After compaction, the mean densities of the first and second layers were 1.3 g/cm³. Except for these, the cell of No. 9 was made in the same way as No. 1. It is considered that the anode active material layer of No. 9 has the multilayer structure of the third example (FIG. 4).

The anode active material layer was formed by coating the entire surface of the first paste on one surface of the anode current collector with a die coater. Except for these, the cell of No. 10 was made in the same way as No. 1.

The anode active material layer was formed by coating the entire surface of the first paste on one surface of the anode current collector with a die coater. Except for these, the cell of No. 11 was made in the same way as No. 2.

The anode active material layer was formed by coating the entire surface of the first paste on one surface of the anode current collector with a die coater. Except for these, the cell of No. 12 was made in the same way as No. 3.

The cells of No. 13 to No. 15 were fabricated in the same way as No. 1, except that no groove portion is formed in the cathode active material layer and the basis weight of each portion is changed as shown in FIG. 6.

As shown in FIG. 6, the cell of No. 16 was fabricated in the same way as No. 1, except that the basis weight and the thickness of the flat portion and the second portion are changed.

As shown in FIG. 6, the cell of No. 17 was fabricated in the same way as No. 1, except that the basis weight in the 2nd part is changed.

### Evaluation

By sandwiching the cell between the two Al plates, a restraining pressure of 0.3 MPa or more was applied to the cell. The initial discharge capacitance was measured by CCCV charge and CCCV discharge as described below, with the cell under a constrained pressure.
CCCV charge: CC current 300 mA, CV voltage 4.2 V, cut current 10 mA
CCCV discharging: CC current 300 mA, CV voltage 2.5 V, cut current 10 mA

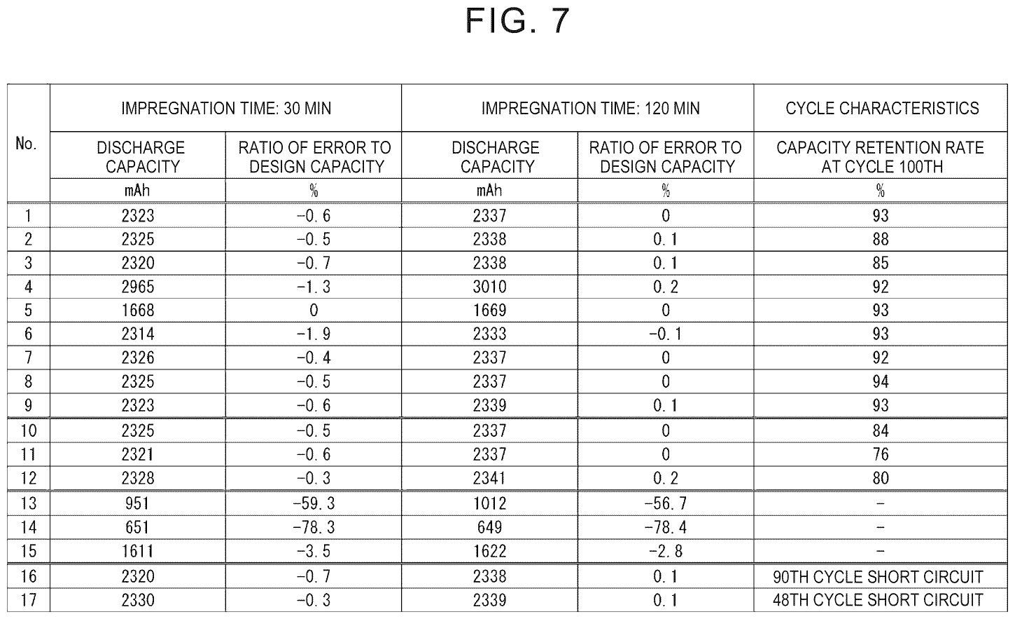

FIG. 7 is a table showing experimental results. The impregnation time indicates the time from the injection of the electrolytic solution to the start of the initial charging. In each sample, the initial discharge capacity was measured at both a 30-minute impregnation time and a 120-minute impregnation time.

Cycle tests were performed on cells with an impregnation time of 120 minutes. 100 cycles of charging/discharging were performed with one cycle of CCCV charge and one cycle of CCCV discharge. The discharge capacity of the 100th cycle, by being divided by the first discharge capacity, the capacity retention rate was calculated.
CCCV charge: CC current 1500 mA, CV voltage 4.2 V, cut current 100 mA
CCCV discharging: CC current 1500 mA, CV voltage 2.5 V, cut current 100 mA

### Results

From “Comparison between No. 1 and No. 10,” “Comparison between No. 2 and No. 11,” and “Comparison between No. 3 and No. 12,” it can be seen that the cycle characteristics tend to be improved by including graphite in the second portion (groove facing portion) of the anode active material layer.

From the comparison of “No. 1, No. 4, No. 5” and “No. 13, No. 14, No. 15,” it can be seen that when there is no groove portion in the cathode active material layer, the discharge capacity tends to be significantly lower than the design capacity. Poor impregnation is considered to be the cause. As the basis weight of the cathode active material layer increases, there is a tendency that insufficient impregnation is likely to occur.

From the comparison of “No. 1, No. 4, and No. 5,” it can be seen that the anode capacitance (C2/C1) of 0.05 or more tends to reduce short-circuit defects. It is considered that even when Li diffuses into the second portion (the groove-facing portion), there is a margin in the receiving capacitance of the second portion. From these results, it is considered that when both the cathode active material layer and the anode active material layer are striped, the occurrence rate of short-circuit failure may be increased.

What is claimed is:

1. A lithium-ion battery comprising:
a cathode;
an anode; and
an electrolytic solution, wherein:
the cathode includes a cathode active material layer;
the cathode includes a flat portion and a groove portion;
a thickness of the cathode active material layer in the groove portion is smaller than a thickness of the cathode active material layer in the flat portion;
the anode includes an anode active material layer;
the anode active material layer includes a first portion and a second portion;
the first portion faces the flat portion;
the second portion faces the groove portion;
the anode active material layer contains an anode active material;
in the first portion, the anode active material contains silicon; and
in the second portion, the anode active material is at least one type selected from a group consisting of graphite and lithium titanate.

2. The lithium-ion battery according to claim 1, wherein the thickness of the cathode active material layer in the groove portion is zero.

3. The lithium-ion battery according to claim 1, wherein a relation of the following Expression (1) is satisfied
$$0.05 \leq C 2 / C 1 \qquad ( 1 )$$
where, in Expression (1),
C1 represents an anode capacitance per unit area in the first portion, and
C2 represents an anode capacitance per unit area in the second portion.

4. The lithium-ion battery according to claim 1, wherein at least one of relations of the following Expression (2) and Expression (3) is satisfied
$$30 mg / {cm}^{2} \leq Ma \qquad ( 2 )$$
$$100 μm \leq Ta \qquad ( 3 )$$
where, in Expression (2), Ma represents a basis weight of the cathode active material layer in the flat portion, and
in Expression (3), Ta represents the thickness of the cathode active material layer in the flat portion.

5. The lithium-ion battery according to claim 1, wherein:
the anode active material layer includes a first layer and a second layer;
the first portion includes the first layer and the second layer;
in the first portion, the second layer is laminated on the first layer;
the second portion is made up of the first layer or the second layer; and
the second layer is of a different composition from the first layer.
